(19) United States
(12) Patent Application Publication
(10) Pub. No.: US 2025/0263198 A1
(43) Pub. Date: Aug. 21, 2025

(54) PROCESS FOR MAKING PALLETS FROM WOODEN MATERIAL

(71) Applicant: IMAL S.r.l., Modena (MO) (IT)

(72) Inventor: Paolo BENEDETTI, Modena (MO) (IT)

(73) Assignee: IMAL S.r.l., Modena (MO) (IT)

(21) Appl. No.: 18/442,141

(22) Filed: Feb. 15, 2024

(51) Int. Cl. B65D 19/00; B27M 3/00

(52) U.S. Cl. CPC B65D 19/0095; B27M 3/0053; B27M 3/0073; B65D 2519/00029; B65D 2519/00064; B65D 2519/00099

(57) ABSTRACT

A process/method for making pallets from wooden material comprises at least the following stages: supply of a plurality of base elements having at least one lower surface intended, in use, to rest on a supporting surface and an upper surface facing, in use, upwards; supply of at least one loading top, wherein the base elements and the loading top are made from wooden material; assembly of the loading top to the upper surface of the base elements to obtain a pallet made from wooden material, wherein the supply of a plurality of base elements comprises at least the following steps: supply of wooden material in the form of fibers and/or flakes; pressing the wooden material so as to obtain at least one of the base elements in a single body piece.

### TECHNICAL FIELD

The present invention relates to a process for making pallets from wooden material.

### BACKGROUND ART

The use of pallets for transporting and storing products of various and different types (e.g., food, pharmaceuticals and so on) is very widespread. Specifically, a pallet substantially comprises a loading top of the aforementioned products and a supporting base of the loading top on a resting surface.

The supporting base usually consists of a plurality of supporting crossbars, e.g. three, associated with the loading top and arranged parallel to each other. In the present case, the supporting crossbars define, between them, gap holes into which the forks of a lifting machinery (e.g., a forklift, a pallet truck, and so on) can be fitted so that the pallet and, therefore, the products arranged therein can be transported.

As is well known, each supporting crossbar is made by chip removal machining from a semi-finished wooden product and is then assembled to the loading top by nailing, gluing or similar processes which allow securing the supporting base to the loading top and, consequently, obtaining the pallet.

That said, it should be explained that this manufacturing process is affected by several drawbacks.

It appears, in fact, clear that the aforementioned production mode of the various wooden crossbars results in massive waste of material in the form of scrap and is, therefore, quite inefficient and economically burdensome to sustain.

In this regard, it should also be kept in mind that the high production of waste material stands in stark contrast to the increasingly stringent ecological regulations governing the amount of industrial processing waste and the release thereof into the environment, eventually making pallet construction even more inconvenient to implement according to known methodologies.

Taking all this into account, it is not surprising that there is nowadays an increasing need to devise a process for making pallets from wooden material which allows significantly reducing the amount of scrap generated compared with the state of the art.

### Description of the Invention

The main aim of the present invention is to devise a process for making pallets from wooden material distinguished by low manufacturing costs and less material waste than the prior art mentioned above.

Within that main aim, one object of the present invention is to devise a process for making pallets from wooden material with the least environmental impact.

Another object of the present invention is to devise a process for making pallets from wooden material provided with peculiar physical-structural properties specifically tuned to their particular intended use.

Another object of the present invention is to devise a process for making pallets from wooden material which allows the aforementioned drawbacks of the prior art to be overcome within the framework of a simple, rational, easy and effective to use as well as low-cost solution.

The aforementioned objects are achieved by this process for making pallets from wooden material having the characteristics of claim 1.

The aforementioned objects are achieved by this wooden pallet having the characteristics of claim 7.

### BRIEF DESCRIPTION OF THE DRAWINGS

Other characteristics and advantages of the present invention will become more apparent from the description of a preferred, but not exclusive, embodiment of a process for making pallets from wooden material, illustrated by way of an indicative, yet non-limiting example in the accompanying tables of drawings, in which:

FIG. 1 shows the step of introducing the first wooden material in accordance with the process according to the invention;

FIG. 2 shows the step of introducing the first wooden material in accordance with the process according to the invention;

FIG. 3 shows the compaction step of the process according to the invention;

FIG. 4 shows the cutting step of the process according to the invention;

FIG. 5 shows the assembly stage of the process according to the invention;

FIGS. 6 and 7 are overall axonometric views of two different embodiments of the pallet according to the invention.

### EMBODIMENTS OF THE INVENTION

With particular reference to these figures, reference numeral 1 globally denotes a pallet made from wooden material.

The process for making pallets from wooden material comprises at least the following stages:
supply of a plurality of base elements 2 having at least one lower surface 2a, intended, in use, to rest on a supporting surface S, and an upper surface 2b facing, in use, upwards;
supply of at least one loading top 4;
assembly of the loading top 4 to the upper surface 2b of the base elements 2 to obtain a pallet 1 made from wooden material.

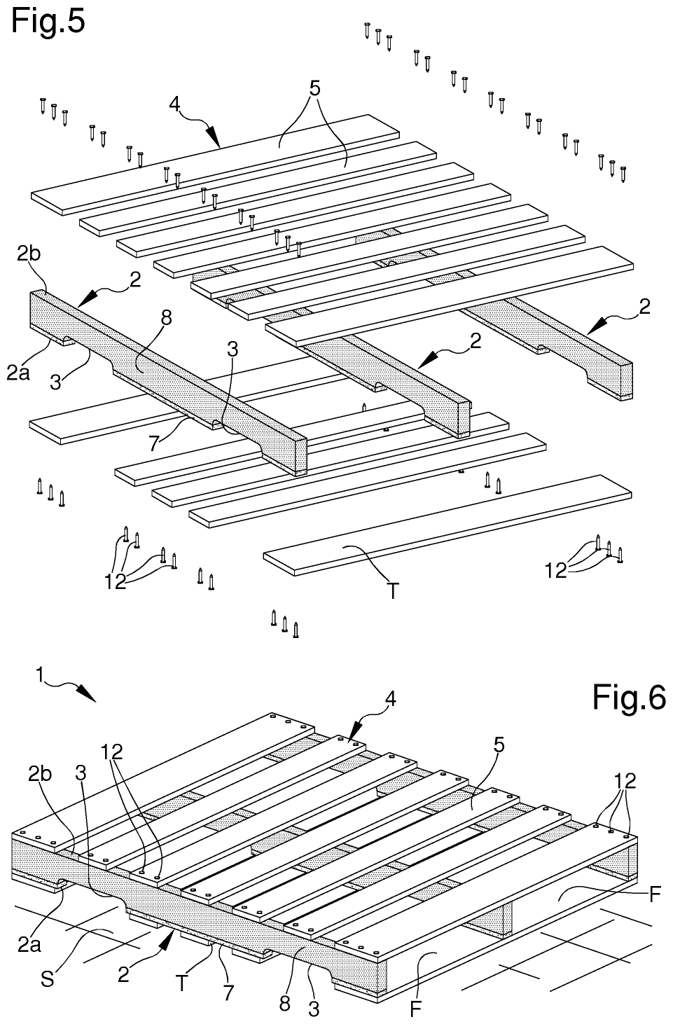

It should be noted, first of all, that the expression “intended, in use, to rest on the supporting surface S” referring to the lower surface 2a comprises both the case in which the latter is placed in direct contact with the supporting surface S (i.e., if the pallet 1 has no components that are arranged in use, between the lower surface 2a and the supporting surface S) and the case, shown in FIGS. 5 and 6, in which there is a plurality of reinforcing beams T of the pallet 1, attached inferiorly to the base elements 2, placed in direct contact with the lower surfaces 2a. In other words, this expression can be indifferently used either to denote a pallet 1 provided with the aforementioned reinforcing beams T (in which case it is, therefore, the latter that are, in use, in direct contact with the supporting surface S) or to denote a pallet 1 without them (in which case it is, therefore, the lower surfaces 2a that are, in use, in direct contact with the supporting surface S).

Appropriately, the reinforcing beams T are arranged spaced apart from each other.

Having specified this, as visible in the figures, the base elements 2 have elongated conformation.

Again, the base elements 2 are made from one or more types of wooden material M1, M2.

During the assembly phase, which will be described in detail later in this disclosure, the base elements 2 are placed at such a distance from each other that they define gap holes F through which the forks of a lifting machine (e.g., a forklift, a pallet truck and so on) can be inserted to allow the pallet 1 to be displaced and loaded.

In accordance with a first embodiment, visible in FIGS. 5 and 6, the base elements 2 are made shaped.

It is specified, in this regard, that the use of the expression “shaped” in relation to the base elements 2 is to be understood as referring to the fact that they each have, at least, a pair of recesses 3 through which the aforementioned forks of the lifting machinery can be inserted (see FIG. 6).

In this sense, the base elements 2 allow the pallet 1 to be forked either through the gap holes F or through the recesses 3, thus promoting the handling of the pallet itself and consequently increasing the versatility of use thereof.

In actual facts, the simultaneous presence of the gap holes F and of the recesses 3 makes it possible to obtain a so-called “4-way” pallet 1, that is, one that can be forked from all four of its sides.

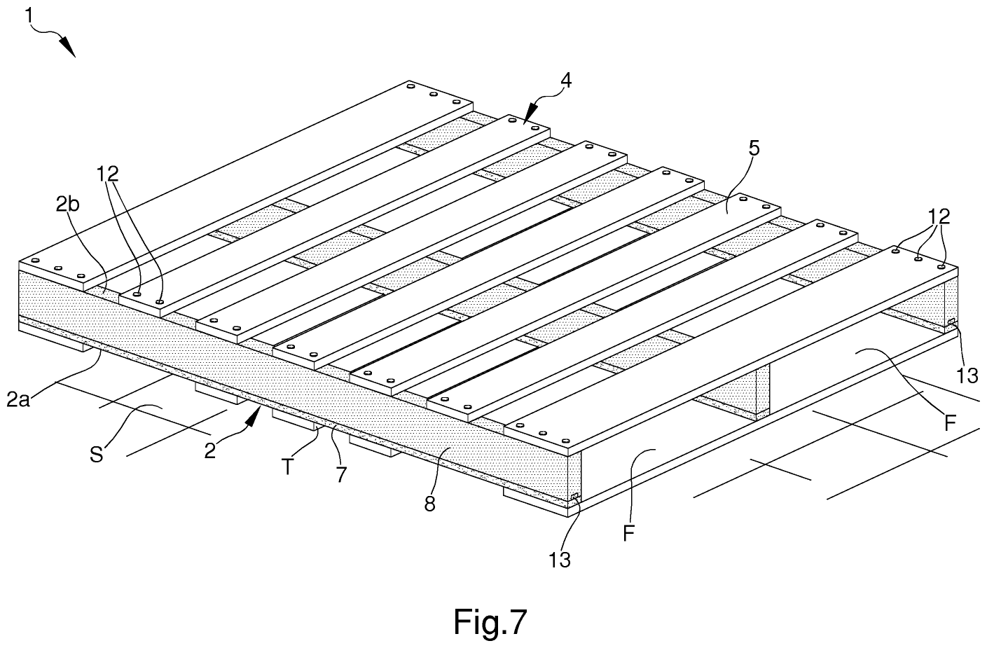

In accordance with a second embodiment shown in FIG. 7, the base elements 2 are without the recesses 3.

In this regard, as visible in the above figure, the base elements 2 can be provided with a special groove 13 adapted to accommodate one or more straps having the purpose of sealing the pallet 1, or be without the groove 13 as well and be, therefore, solid.

It is worth noting, in this regard, that the special expedient of providing a groove 13 for housing the strap enables the transport of the pallet 1 to be somewhat simplified, making the handling thereof considerably safer and more efficient.

As for the loading top 4, it too is made from wooden material.

Specifically, the loading top 4 comprises a plurality of loading elements 5 having elongated conformation.

The loading elements 5 are associated with the upper surface 2b of the base elements 2 and are arranged spaced apart from each other.

In this case, each of the loading elements 5 substantially consists of a wooden crossbar.

In the embodiment involving both loading elements 5 and reinforcing beams T, the loading elements 5 and the reinforcing beams T are arranged aligned with each other.

According to the invention, the supply of a plurality of base elements 2 comprises at least the following steps:
supply of wooden material M1, M2 in the form of fibers and/or flakes;
pressing the wooden material M1, M2 so as to obtain at least one of the base elements 2 in a single body piece.

More particularly, the wooden material M1, M2 is of the loose type.

Preferably, each base element 2 of the pallet 1 is obtained in a single body piece by means of the pressing step.

In this regard, it is pointed out that the special expedient of making at least one base element 2 in a single body piece by pressing enables the drawbacks of the prior art complained of earlier to be overcome.

In fact, this technical expedient makes it possible to greatly reduce material waste during the production process of the pallet 1 and, with it, the cost of making it.

By producing less scrap and, therefore, less processing waste, the process according to the invention is, among other things, also particularly advantageous from an ecological point of view, resulting in a significantly lower environmental impact than traditional processes.

Conveniently, pressing is done by hot stamping, and the wooden material is supplied together with an adhesive material of the thermosetting type.

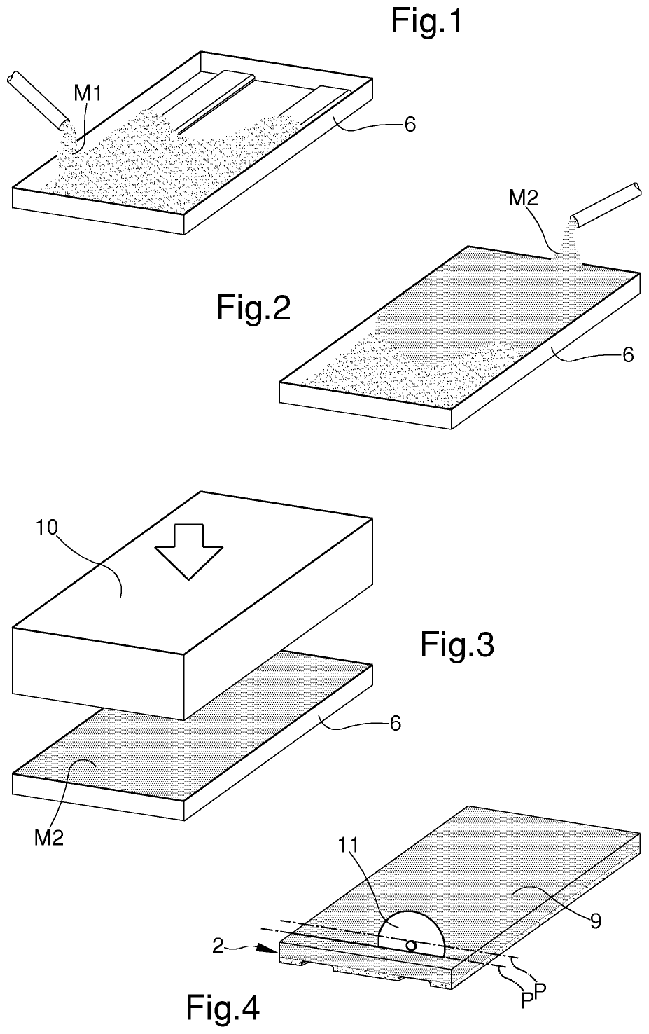

In this case, stamping comprises at least the steps of:
supply of at least one mold 6 for forming the at least one base element 2;
introduction of a first wooden material M1 into the mold 6 (see FIG. 1);
introduction of a second wooden material M2 into the mold 6 (see FIG. 2);
compaction of the wooden materials M1, M2 introduced inside the mold 6 (see FIG. 3).

The wooden materials M1 and M2 have different types and/or densities from each other.

In a first embodiment, the first wooden material M1 and the second wooden material M2 are of different types and may have equal or different densities.

In a second embodiment, the first wooden material MI has a first density and the second wooden material M2 has a second density different from the first density.

Thus, the resulting base element 2 has at least a first portion 7 having a first density and at least a second portion 8 having a second density different from the first density.

It should be noted how the possibility of making portions 7, 8 having different densities from each other gives the process covered by this invention considerable versatility, the latter allowing to obtain pallets 1 having physical-structural characteristics specifically calibrated to their precise intended use.

Conveniently, the first density is greater than the second density.

In other words, the density of the first portion 7 is greater than the density of the second portion 8.

Again, in the second described embodiment, in which the wooden materials M1 and M2 have different densities from each other, the introduction of the first wooden material M1 is preferably carried out prior to the introduction of the second wooden material M2.

In this way, the first portion 7 is arranged, in use, resting on the supporting surface S, while the second portion 8 is placed between the first portion 7 and the upper surface 2b.

By doing so, the weight of the loading top 4 and of the products possibly arranged thereon burdens mainly on the portion with higher density, i.e., on the first portion 7; it is easy to appreciate how this solution causes an advantageous increase in the structural strength of the pallet itself as well as in its overall stability.

That said, alternative embodiments cannot be ruled out wherein, e.g., the introduction of the second wooden material M2 is carried out prior to the introduction of the first wooden material M1.

In other words, it cannot be ruled out that the stamping is carried out in such a way as to obtain a base element 2 where the second portion 8 is arranged, in use, resting on the supporting surface S and where the first portion 7 is placed between the second portion 8 and the upper surface 2b.

Conveniently, pressing comprises at least the steps of:
forming at least one semi-finished body 9 in a single body piece; and of
cutting the semi-finished body 9 along one or more cutting directions P parallel to each other to obtain a plurality of base elements 2 (see FIG. 4).

Forming is done, preferably, by means of pressing means 10, e.g. of the type of hydraulic presses or other types still known to the expert in the field.

Conveniently, the mold 6 has a substantially complementary conformation to that of the semi-finished body 9 to enable the latter to be formed as a result of the compaction of the wooden material M1, M2.

In this regard, as visible in FIG. 4, the semi-finished body 9 is substantially conformed to a parallelepiped shape.

More specifically, the width of the semi-finished body 9 is substantially coincident with the length of the base elements 2 made therefrom.

In this sense, the cutting directions P are arranged substantially transverse to the semi-finished body 9, that is parallel to the width thereof.

Again, the cutting directions P are set at a substantially constant distance from each other and such as to allow, as a result of cutting, obtaining the base elements 2 having a desired and equal size to each other.

Conveniently, the cutting step is performed by means of cutting means 11 adapted to effectively work the semi-finished body 9.

Specifically, the cutting means 11 are of the type of a wood saw or of a similar tool known to the expert in the field.

Advantageously, the assembly comprises at least one of the following steps:
bonding the loading top 4 to the base elements 2 by interposition of adhesive means; and
fastening the loading top 4 to the base elements 2 by interposition of a plurality of fastening elements 12 (see FIG. 5).

Specifically, the fastening elements 12 are of the type of nails, screws or similar members.

In this regard, the assembly of the loading elements 5 to the base elements 2 is preferably done in such a way that the former can be arranged parallel to each other and substantially orthogonal to the latter.

Thus, the assembly stage allows the base elements 2 and the loading top 4 to be stably joined together and, in doing so, to obtain the pallet 1.

Just in this sense, according to a further aspect of the invention, the present invention also relates to a wooden pallet 1.

Preferably, the pallet 1 is produced by means of the process described so far.

The pallet 1 comprises:
a plurality of base elements 2 having at least one lower surface 2a intended, in use, to rest on a supporting surface S, and an upper surface 2b facing, in use, upwards;
at least one loading top 4 locked together with the base elements 2 where the relevant upper surfaces 2b are located.

Similar considerations about the meaning of the expression “intended, in use, to rest on a supporting surface S” referring to the lower surface 2a should be considered valid here as well, so they are not repeated.

According to the invention, at least one base element 2 is made in a single body piece by pressing the wooden material M1, M2 in the form of flakes and/or powders.

It is reiterated how this expedient achieves the previously stated advantages regarding the reduction of waste material produced and the lower implementation costs associated therewith.

In addition to this, the less waste generated also means that the pallet 1 results in a reduced environmental impact compared to known pallets and is, in this sense, significantly more suitable than the latter in the pursuit of today's sustainability goals.

Conveniently, at least one of the base elements 2 comprises at least a first portion 7 having a first density and at least a second portion 8 having a second density different from the first density.

In this case, the first density is higher than the second density.

In this regard, the first portion 7 is arranged, in use, resting on the supporting surface S, while the second portion 8 is placed between the first portion 7 and the upper surface 2b.

The fact of providing for a first portion 7 thus arranged and provided with higher density than the second portion 8 results, therefore, in a convenient increase in the structural strength and stability of the pallet 1, enabling the latter to effectively hold the products arranged on the loading top 4.

It is also important to note that, in general, the fact of providing for base elements 2 provided with portions having different densities from each other makes it possible to greatly increase the versatility of the pallet 1 with respect to the prior art, thus giving the latter peculiar physical characteristics specifically calibrated to its precise intended use.

It has in practice been ascertained that the described invention achieves the intended objects.

In particular, the fact is emphasized that the special expedient of making at least one base element in a single body piece by pressing significantly lowers the waste of wooden material compared to the prior art, with the result of reducing, compared to known processes, the costs related to the production of the pallet and the environmental impact.

1. A process for making pallets from wooden material, the process comprising at least the following stages:
supply of a plurality of base elements having at least one lower surface intended, in use, to rest on a supporting surface and an upper surface facing, in use, upwards;
supply of at least one loading top, wherein said base elements and said loading top are made from wooden material;
assembly of said loading top to said upper surface of said base elements to obtain a pallet made from wooden material,
wherein said supply of a plurality of base elements comprises at least the following steps:
supply of wooden material in the form of fibers and/or flakes; and
pressing said wooden material so as to obtain at least one of said base elements in a single body piece.

2. The process according to claim 1, wherein said pressing is done by stamping.

3. The process according to claim 2, wherein said pressing comprises at least the steps of:
supply of at least one mold for forming said at least one base element;
introduction of a first wooden material into said mold;
introduction of a second wooden material into said mold; and of
compaction of said wooden materials introduced inside said mold.

4. The process according to claim 3, wherein said second wooden material is of different type and/or density from said first wooden material.

5. The process according to claim 4, wherein said first wooden material has a first density and wherein said second wooden material has a second density different from said first density, said resulting base element having at least a first portion having a first density and at least a second portion having a second density different from the first density.

6. The process according to claim 5, wherein:
said first density is higher than said second density; and wherein
said introduction of said first wooden material is carried out prior to said introduction of said second wooden material so that said first portion is arranged, in use, resting on said supporting surface and said second portion is placed between said first portion and said upper surface.

7. The process according to claim 2, wherein said pressing comprises at least the steps of:
forming at least one semi-finished body in a single body piece; and of
cutting said semi-finished body along one or more cutting directions parallel to each other to obtain a plurality of base elements.

8. The process according to claim 1, wherein said assembly comprises at least one of the following steps:
bonding said loading top to said base elements by interposition of adhesive means; and
fastening said loading top to said base elements by interposition of a plurality of fastening elements.

9. A wooden pallet comprising:
a plurality of base elements having at least one lower surface intended, in use, to rest on a supporting surface and an upper surface facing, in use, upwards; and
at least one loading top locked together with said base elements where the relevant said upper surfaces are located;
wherein at least one of said base elements is made in a single body piece by pressing wooden material in the form of flakes and/or powders.

10. The wooden pallet according to claim 9, wherein at least one of said base elements comprises at least a first portion having a first density and at least a second portion having a second density different from said first density.

11. The wooden pallet according to claim 10, wherein said first density is higher than said second density and wherein said first portion defines said lower surface and said second portion defines said upper surface.

12. The wooden pallet according to claim 9, wherein said loading top comprises a plurality of loading elements having elongated conformation, said loading elements being locked together with said base elements, where the relevant upper surfaces are located, and arranged spaced apart from each other.

13. The wooden pallet according to claim 9, comprising a plurality of reinforcing beams locked together with said base elements, where the relevant lower surfaces are located, and arranged spaced apart from each other.

14. The wooden pallet according to claim 13, wherein said reinforcing beams are substantially aligned with said loading elements.

15. A method for making pallets from wooden material, the method comprising:
supplying of a plurality of base elements having at least one lower surface intended, in use, to rest on a supporting surface and an upper surface facing, in use, upwards;
supplying of at least one loading top, wherein said base elements and said loading top are made from wooden material;
assembling of said loading top to said upper surface of said base elements to obtain a pallet made from wooden material,
wherein said supply of a plurality of base elements comprises at least the following:
supplying of wooden material in the form of fibers and/or flakes; and
pressing said wooden material so as to obtain at least one of said base elements in a single body piece.
